(19) United States
(12) Patent Application Publication
(10) Pub. No.: US 2015/0039523 A1
(43) Pub. Date: Feb. 5, 2015

(54) METHODS AND DEVICES FOR URBAN PLANNING

(71) Applicant: UNIVERSITAT DE GIRONA, Girona (ES)

(72) Inventors: Maria Lluïsa MARSAL LLACUNA, TOSSA DE MAR (ES); Maria Beatriz LÓPEZ IBÁÑEZ, PALS (ES)

(73) Assignee: UNIVERSITAT DE GIRONA, Girona (ES)

(21) Appl. No.: 13/954,802

(22) Filed: Jul. 30, 2013

(51) Int. Cl. G06Q 50/16; G06Q 10/10

(52) U.S. Cl. CPC G06Q 50/163; G06Q 10/109
USPC 705/314

(57) ABSTRACT

Methods and devices for quantitatively mapping urban time uses to land uses in an urban unit and methods and devices for classifying urban units are disclosed. In some aspects, for each activity an associated time to be spent for the activity in one urban unit is used to provide an activity allocation parameter to be used when planning a second urban unit. In other aspects, performance indicators compared to their respective activity allocation parameters are used to classify the urban units. In one example, urban units are classified as self-sufficient or non-self-sufficient based on activity allocation parameters.

The present disclosure is related to real estate and more specifically to urban planning.

### BACKGROUND ART

The main purpose of the urban planning discipline is to meet the urban needs of citizens. These are for the most part focused on decent and affordable housing, convenient public transport, accessible and sufficient public services placed in public facilities, and safe and livable public spaces. All of these basic urban planning purposes are in crisis, due to: a) Obsolescence of the planning values (and thus rules and procedures) used by urban planners, and b) The impoverished role of citizens in the overall planning process.

Traditional urban planning methods include rules and procedures which are based on planning values, which are in large part derived from the experience of urban planners. Therefore, traditional planning proposals are not only subjective, but sometimes even biased, due to political and other influences. Urban Planning Acts generally provide recommended values and/or planning standards for the amount of urban lands and their allocated uses (such as public spaces, facilities, housing, roads, commercial, etc.). Many of these recommended values and planning standards were created during the urban planning exercises of the 1970's, or even earlier. Since this foundational era, most countries have failed to update their urban planning design values, and still use them as the basis for city master plans. Even updated and recent city master plans are often based on antiquated planning design values. This situation needs to be addressed now. Cities are completely different, and the needs of citizens have changed dramatically.

In some areas, traditional public participation in the urban planning approval process includes mainly citizen validation of proposed master plans. It is normally organized as a three-step approval process, requiring a public vote before passing to the next step. First of all, the basic city design schema is submitted for the so-called master plan initial approval, which is binding at the municipal level. At this point, citizens can only express whether or not they like the first initial layout. The second step, which is called the master plan provisional approval, involves a more detailed proposal, which is binding at the regional level and involves the regional administration (if it has jurisdiction under national law). Once again, citizens are only empowered to accept or decline the master plan. The third and last step, the master plan final approval, corresponds to the regional or even national administration, and the role of citizens is still restricted to validation.

Public participation in the urban planning approval processes has been up to now a mere formality, limited to the validation of master plan proposals. However, societies and municipalities are much more “social” than forty years ago. Citizens want cities and their governing bodies to serve them in the most optimal fashion. Using new technology, social media, and enhanced access to information, citizens want to be acknowledged, empowered, engaged, informed, and given multiple avenues to contribute to the design of their cites and the ways that their lives unfold. Citizens are becoming more reluctant to accept public participation which is structured merely as a formality, completing an administrative approval process that took place behind closed doors. Therefore, urban planning processes should expand the role of citizens and integrate their opinions in the earliest stages. Citizens are and need to be treated as the source of the most important and up-to-date data that must form the basis of urban planning values and standards. To revise and update planning values, and make them correspond to the needs of citizens, a more citizen-centered approach with expanded public participation is required as part of an improved urban planning method.

### SUMMARY OF THE INVENTION

It is an object of this disclosure to improve the urban planning process by providing urban planning design values from the actual experience of citizens, and be based upon their opinions and desires concerning their urban needs and how they want to use their cities.

The methodology according to the disclosure may utilize web-based opinion surveys and data mining tools to establish new values and rules for urban planning.

The proposed urban planning method includes an objective approach that is distinct from the traditional ones. It uses a rule of correspondence and indicators of equivalence between urban time use and urban land use as tools for updating urban planning design values. To develop the urban planning method the inverse engineering concept is used, under which the initial parameters are unknown and may be determined in relation to the desired target.

In other words, the causal parameters for an observed or desired effect may be determined. Solving a problem using inverse engineering techniques usually requires two computational tasks: first, simulating the problem, and second, selecting the optimal solution. In the context of the Smart City Initiative, the proposed urban planning method addresses the problem of obsolete urban planning design techniques. It does so by meeting the urban needs of citizens (target) through an ICT-based citizen-centered method (solution), collecting data regarding the desired use of the city (simulation) for establishing the new urban planning design values (initial parameters).

To develop the urban planning method, inverse engineering principles are applied as follows: The problem of giving a real and accurate answer to citizens' needs is tackled through the proposed algorithm which transforms the urban time use of citizens into urban land use, obtaining rules of correspondence and indicators of equivalence between urban time use distributions and urban land use allocations. To that end, citizens are questioned on a) their current urban activities during a twenty four hour time period, and b) their desired or ideal scenarios for urban activities. The rule of correspondence and indicators of equivalence may operate with two sets of values, those obtained from citizens' real use of the city, and those obtained from citizens' desired or ideal use of the city. Thus, the optimal urban land use allocation which may form the basis for design will be the set of urban land use values corresponding to citizens' desired use of their city.

The proposed method is the first to correlate urban time use distribution and urban land use allocation.

In a first aspect a method of quantitatively mapping urban time use to land use is disclosed. In a first step, at least a first activity C1 to be carried out within a first urban unit U1 may be identified. In a second step, a first associated time T1 to be spent for the first activity C1 may be identified. In a next step, a first land area size L1 where activity C1 takes place may be identified. Next, an activity allocation parameter A1 may be defined as a proportion of T1 and L1. Then, a first desired time Td1 may be identified as the amount of desired time to be spent for activity C1 in a second urban unit U2. Finally, a second land area size L12 of the second urban unit U2 may be set, as a function of Td1 and A1.

The urban unit U1 may be a city or a district or even a neighbourhood. The first associated time T1 may be the total time that the citizens of U1 spend in activity C1 in a given time period of 24 h. L1 may be the size of the actual available land area for activity C1 in U1. When T1 is equal to a desired time Td1 to be ideally spent for activity C1 in U1, then L1 is the ideal size for said activity C1. Therefore, A1 may be considered an activity allocation standard for activity C1 for all urban units. As a consequence, any urban unit may be planned accordingly for activity C1. Any urban unit that fulfils the activity allocation standard A1 may then be considered as “self-sufficient” for activity C1. That means that any urban unit with enough land area so that the proportion of associated time to the assigned land area matches or exceeds A1 may be considered self-sufficient.

In some embodiments of the method, a plurality of activities C1 to Cn to be carried out within a plurality of urban units may be identified. Then, a plurality of associated times T1 to Tn to be spent for the activities C1 to Cn may be identified, respectively. Next, a plurality of land area sizes L1 to Ln where activities C1 to Cn take place may be identified, respectively; This may allow a plurality of activity allocation parameters A1 to An to be defined, each as a proportion of Ti and Li, respectively, i belonging to [1, . . . , n]. As a next step, a plurality of desired times Td1 to Tdn may be identified as the amount of desired time to be spent for activities C1 to Cn in the second urban unit U2. Finally, a plurality of land area sizes L12 to Ln2 of the second urban unit U2 may be set, each as a function of Tdi and Ai, respectively, i belonging to [1, . . . , n].

When there is a plurality of activities C1 to Cn that are common to a plurality of urban units U1 to Um, it may be assumed that some urban units are self-sufficient in some activities and some in other activities. As a consequence each activity allocation parameter A1 to An may be based on measurements taken in different urban units. In that sense, an ideal urban unit would be self-sufficient in all activities C1 to Cn by fulfilling A1 to An. When planning the second urban unit U2 the parameters A1 to An of the ideal urban unit may be taken into account.

In some embodiments, each of the activity allocation parameters A1 to An may be based on a proportion of Ti and Li of an urban unit belonging to the plurality of urban units. In some cases, the different allocation parameters A1 to An may be obtained from different urban units from the plurality of the urban units.

In another aspect, a method of classifying a plurality of urban units U1 to Um is disclosed. Initially a process of quantitatively mapping urban time use to land use may take place for the activity C1 for the urban units U1 to Um, substantially as herein before described. Then, a plurality of performance indicators P11 to P1m may be defined, each corresponding to a proportion between an associated time T1j, corresponding to the time spent in urban unit Uj for activity C1, and L1j, corresponding to the land area size used for said activity C1 in urban unit Uj, j belonging to [1, . . . , m], respectively. Finally, the urban units U1 to Um may be classified based on P11 to P1m.

In some embodiments, when P1j≧A1 the corresponding urban unit may be considered self-sufficient.

Given a set of urban units U1 to Um, their respective actual associated time T11 to T1 m spend in activity C1 and their corresponding land areas L11 to L1m, a plurality of performance indicators P11 to P1m may be defined. Then, the urban units U1 to Um may be classified according to their respective performance indicators. In one classification example, when a performance indicator matches or exceeds the corresponding activity allocation parameter A1, then, the urban unit may be considered self-sufficient.

In some embodiments, the process of quantitatively mapping urban time use to land use may involve a plurality of activities C1 to Cn. In that case, a plurality of performance indicators P11 to Pnm for the plurality of activities C1 to Cn may be defined. Then, the urban units U1 to Um may be classified based on P11 to Pnm.

In some embodiments, when Pij≧Ai then the corresponding urban unit may be considered self-sufficient with respect to the activity Ci.

When all performance indicators P11 to Pnm have been defined for the plurality of activities C1 to Cn and for all urban units U1 to Um, then a classification matrix may be constructed such as a self-sufficiency matrix based on A1 to An.

Ideally, a land area that has been planned according to citizen needs with respect to a plurality of activities may be considered “partially self-sufficient” if only some performance indicators match or exceed the corresponding activity allocation parameters or “totally self-sufficient” if all the performance indicators match or exceed the corresponding activity allocation parameters.

In yet another aspect, a device for quantitatively mapping urban time use to land uses is disclosed. The device may comprise a memory and a processor, embodying instructions stored in the memory and executable by the processor. The instructions may comprising functionality to: receive at least a first identifier corresponding to an activity C1 to be carried out within a first urban unit U1; receive a first associated time value T1 corresponding to the time spent for the first activity C1; receive a first value L1 corresponding to the land area size where activity C1 takes place; calculate an activity allocation parameter A1 as a proportion of T1 and L1; receive a first desired time value Td1 corresponding to the amount of desired time to be spent for activity C1 in a second urban unit U2; and, finally, calculate a second value L12 as a function of Td1 and A1, wherein L12 corresponds to the sufficient land area size of the second urban unit U2 for activity C1.

In some embodiments the device may further comprise instructions comprising functionality to receive a plurality of identifiers corresponding to activities C1 to Cn to be carried out within a plurality of urban units; receive a plurality of associated time values T1 to Tn corresponding to the times to be spent for the activities C1 to Cn, respectively; receive a plurality of values L1 to Ln corresponding to the land area sizes where activities C1 to Cn take place, respectively; calculate a plurality of activity allocation parameters A1 to An each as a proportion of Ti and Li, respectively, i belonging to [1, . . , n]; receive a plurality of desired time values Td1 to Tdn corresponding to the amounts of desired time to be spent for activities C1 to Cn in the second urban unit U2; and, finally, calculate a plurality of values L12 to Ln2 , each as a function of Tdi and Ai, respectively, i belonging to [1, . . . , n], wherein L12 to Ln2 correspond to the sufficient land area sizes of the second urban unit U2 for the activities C1 to Cn, respectively.

In some embodiments the device may further comprise instructions comprising functionality to calculate a plurality of performance indicators P11 to P1m, each corresponding to a proportion between an associated time T1j. T1j may correspond to the time spent in urban unit Uj for activity C1, and L1j may correspond to the land area size used for said activity C1 in urban unit Uj, j belonging to [1, . . . , m], respectively. Finally, the device may further comprise instructions comprising functionality to classify the urban units U1 to Um, based on P11 to P1m.

In some embodiments the device may further comprise instructions comprising functionality to calculate a plurality of performance indicators P11 to Pnm for the plurality of activities C1 to Cn and classify the urban units U1 to Um, based on P11 to Pnm.

In yet another aspect, a computer implemented method of quantitatively mapping urban time use to land use is disclosed. In a first step a computer executable logic module may be provided. The logic module may receive at least a first identifier corresponding to an activity C1 to be carried out within a first urban unit U1; receive a first associated time value T1 corresponding to the time spent for the first activity C1; receive a first value L1 corresponding to the land area size where activity C1 takes place; calculate an activity allocation parameter A1 as a proportion of T1 and L1; receive a first desired time value Td1 corresponding to the amount of desired time to be spent for activity C1 in a second urban unit U2; and, calculate a second value L12 as a function of Td1 and A1. L12 may correspond to the sufficient land area size of the second urban unit U2 for activity C1.

In some embodiments, the computer implemented method may further comprise the steps of receiving a plurality of identifiers corresponding to activities C1 to Cn to be carried out within a plurality of urban units; receiving a plurality of associated time values T1 to Tn corresponding to the times spent for the activities C1 to Cn, respectively; receiving a plurality of values L1 to Ln corresponding to the sizes of the land areas where activities C1 to Cn take place, respectively; calculating a plurality of activity allocation parameters A1 to An each as a proportion of Ti and Li, respectively, i belonging to [1, . . . , n]; receiving a plurality of desired time values Td1 to Tdn corresponding to the amounts of desired time spent for activities C1 to Cn in the second urban unit U2; and, finally, calculating a plurality of land area sizes L12 to Ln2 of the second urban unit U2, each as a function of Tdi and Ai, respectively, i belonging to [1, . . . , n].

In some embodiments, the computer implemented method may further comprise the step of calculating a plurality of performance indicators P11 to P1m, each corresponding to a proportion between an associated time T1j. T1j may correspond to the time spent in urban unit Uj for activity C1, and L1j may correspond to the land area size used for said activity C1 in urban unit Uj, j belonging to [1, . . . , m], respectively. Then, the computer implemented method may further comprise the step of classifying the urban units U1 to Um, based on P11 to P1m.

In some embodiments, the computer implemented method may further comprise the steps of calculating a plurality of performance indicators P11 to Pnm for the plurality of activities C1 to Cn and classifying the urban units U1 to Um, based on P11 to Pnm. Therefore, a citizen may, for example, select an area for living based on that information, assuming the desired activities are of importance to the citizen. By classifying the urban units based on their corresponding performance indicators it is also possible to identify the urban units that are more self-sufficient than others taking into consideration a plurality of activities. This facilitates the identification of the more concise urban units which are more or less habitable for citizens according to one or more activities.

Additional objects, advantages and features of embodiments of the invention will become apparent to those skilled in the art upon examination of the description, or may be learned by practice of the invention.

### BRIEF DESCRIPTION OF THE DRAWINGS

Particular embodiments of the present invention will be described in the following by way of non-limiting examples, with reference to the appended drawings, in which:

FIG. 1 shows an example of the rule of correspondence between desired time spent and land usage for a number of activities.

FIG. 1A is a flow diagram of a method of quantitatively mapping urban time uses to land uses according to an embodiment.

FIG. 1B is a block diagram of a device for quantitatively mapping urban time uses to land uses according to another embodiment.

FIG. 2 shows an example of classifying urban units in terms of self sufficiency of land uses.

FIG. 2A is a flow diagram of a method of classifying self-sufficiency in land uses of a plurality of urban units U1 . . . Um according to an embodiment.

FIG. 2B is a block diagram of a device for classifying self-sufficiency in land uses of a plurality of urban units U1 . . . Um, according to an embodiment.

### DETAILED DESCRIPTION OF EMBODIMENTS

According to the present disclosure, information from citizens may form the basis for the design values for master plans: Distinct from the traditional urban planning participatory processes, the proposed opinion survey may occur prior to the design of the master plan. Citizens may be surveyed on their real and desired urban activities during a total time period where each activity will appear at least once, for example during a twenty-four hour time period, for both working and non-working days. Imported and exported hours of citizens who perform their activities in a municipality other than their place of residence may be considered burdens or benefits to the corresponding municipalities, and duly accounted for. For example, citizens working in a city were they do not live may place a burden on public services (unless they pay some additional city taxes), and their working hours may be calculated as time which is exported from their city of residence.

It is necessary to keep in mind that the urban planning method disclosed herein considers the desired use of the city as the simulation providing the optimal scenario to redefine the urban planning design values. Under the current traditional approach, public participation in urban planning processes may not generate collective intelligence. It settles for building limited consensus after the process is underway, instead of gathering data and assessing the desires of citizens during formulative stages.

The present disclosure utilizes opinion surveys launched prior to the urban planning process to achieve more objective planning, and ease the approval process for master plans through a citizen-centered approach that promotes satisfaction.

In the current section, the different steps of the proposed method are explained, from survey design to results and rules obtained. Results include the new planning values out of the correlation between urban time use and urban land use, which may correspond to the average satisfaction threshold of citizens for each specific correlation. In addition to the conversion rule between urban time use and urban land use serving values for municipal land use design, an example of a further application of the proposed method is provided. This example of the application of the method includes a classification rule for categorizing municipalities at the regional level according to the satisfaction thresholds of citizens.

To learn about the covered and uncovered urban needs of the citizens of an urban unit, a survey on urban time use may be conducted. Respondents may be questioned concerning how they are using the city today (which may indicate how well their urban needs are covered), plus how they would like to use the city under more ideal conditions (which may reveal their uncovered urban needs).

In order to not limit respondents' answers and thus obtain more accurate results, the option of inverting the order of “total survey design” implied techniques may be taken. The focus may be on questions concerning the physical allocation of time devoted to urban activities. Stylized respondent reports and time diaries are the two of the most widely used methods that may be used for surveying time use. The former asks respondents to report how much time they usually spend on a specific activity during a certain period of time, while the later asks respondents to report all activities they perform in temporal order and during a single day. A survey combining both methods may be conducted, asking for the description of a typical working and non-working day, and the amounts of time spent in all of the involved activities.

A description of a typical day stands for the average time spent on all daily activities, taking recent weeks as a timeline. Presumably, the measures obtained using the two original methods should be consistent with each other at the aggregate level. That is to say, the stylized measure of time spent on a certain activity should be similar to the total time spent on the same activity, as noted in a time diary for the same period. In some cases, respondents may report higher values in stylized measure, and sometimes they report values which are lower than the total amount of time recorded in time diaries. To avoid such inconsistencies, the combined method asks respondents to report on the time distribution of their activities over a twenty-four hour period, in terms of physical allocation of time. This avoids issues regarding whether or not the time committed to an activity has to be accounted with the activity. Thus, for example, meals at work and training or other events at the work place are counted as time at work, but transportation to work is counted as commuting time.

Through questions on the physical allocation of time, the proposed method may minimize the burden for respondents, by reducing the number of activities that they have to report. Yet it may still preserve the advantages of time diaries, which provide accurate measurement and reduce distortions associated with social desirability bias. However, the possibility of inconsistencies may still be acknowledged derived from the request to describe the twenty-four hour sequence of a typical working and a standard non-working day when respondents do not have routines. This is more likely to be the case for non-working days. Therefore, it may be assumed that respondents may be reporting more the activities mode than the activities mean.

The answers may be organized by urban unit, for example by municipality. The survey text answers may be numerically converted into a twenty-four hour time distribution for both working and non-working days. Activities performed in the city of residence may be positively accounted in the municipality, and activities performed in a non-residence city may be negatively accounted. Thus, it is possible to track exported and imported hours between municipalities. This also may serve as an initial correction factor to design a fair rule of correspondence between urban time use and urban land use at both municipal and regional levels.

Tables may be created for each municipality from which dependency answers may be obtained (municipalities importing hours). These municipalities may be called “head municipalities”. Subsidiary or “dependent municipalities” may export hours to the head municipalities.

Next, to apply the conversion rule between the respondents' current twenty-four hour urban time use distribution for a typical working and non-working day and the corresponding urban land use allocation, urban time use may be mapped into the corresponding physical locations. Time use distribution may be allocated according to the physical location of performance, in order to establish the targeted direct correlation between urban time use and urban land use. Therefore, survey questionnaires and results on urban time use may be expressed according to the following example physical urban locations:
House: Number of hours spent at home
Work: Number of hours spent at work (including all activities conducted at the work place, such as time spent in training or at the cantina, etc.)
Main Facilities: Number of hours spent in a facility which constitutes respondent's main activity (equivalent to a university for students or a day-center for pensioners)
Secondary Facility: Number of hours spent in a facility other than the one constituting respondent's main activity (such as a library, sports facility, learning center, etc.)
Consumption: Number of hours invested in consumer activities (such as shopping, eating in restaurants, going to the cinema, etc.) or personal services (going to the hair dresser, visiting a private doctor, etc.)
Public Space: Number of hours spent in public spaces (including city squares, parks and gardens), but not including mere transit
Public Transport: Number of hours commuting with public transport
Private Transport: Number of hours commuting with private transport.
Self-transport: Number of hours commuting on foot or bicycle
Outdoors: Number of hours spent in natural surroundings outside of the urban unit (mountains, beaches, rivers, natural parks, walking trails, farms and orchards, etc.)
Different city: Number of hours spent in a city other than that of residence, performing activities other than those specified above (visiting friends, weekend stays in a holiday house, etc.)

Applying the rule of correspondence, the indicators of equivalence or activity allocation parameters between the time spent on each urban activity and its location may be found. The rule of correspondence and indicators of equivalence may be calculated for each urban unit, as correlations between time and land are variable. Rule of correspondence and indicators of equivalence may be calculated for each urban unit in which responses are obtained, and weighted according to the number of responses. The indicators of equivalence obtained in the current correlation between urban time use and urban land use may serve as a basis for the new urban planning design values. However, they must be adjusted to account for desired urban time use.

Thus, the new urban planning design values may be obtained as follows: Using the activity allocation parameters obtained for the correspondence between current time and land use, and knowing the desired time use distribution, correlative equations may be used to obtain the land-use allocation corresponding to the desired activities time-distribution.

Common urban parameters of the urban unit forming part of the present research (such as population, urban surface, facilities surface, number of facilities, etc.,) together with the self-sufficiency threshold already obtained may constitute the training data set to be run in data mining tools to find rules for an automatic classification of any urban unit.

This may obviate data for all of the parameters contained in the training data set. For instance, classification rules may help classify any urban unit in terms of services self-sufficiency on the basis of one set of data (such as total surface of facilities, population, etc.). For the purpose of obtaining classification rules of municipal self-sufficiency a decision tree generation algorithm may be used.

For the purpose of finding classification rules for a plurality of urban units, a file containing values on the already mentioned urban parameters included in the training set may be processed. The file may contain a number of attributes relevant to determining the self-sufficiency of municipalities or other urban units (such as suburbs or borrows) in a selected activity or plurality of activities. As an example the file may contain attributes relevant to determining self-sufficiency in the urban sub-system of services offered in facilities. This may include urban land surface, population, facilities area, number of services contained in facilities, etc. The attribute “self-sufficiency” is the class. The urban units may be the number of instances. Although the concept of self-sufficiency for a selected activity shall be explained with the example of services offered in facilities, one skilled in the art may appreciate that similar determination of self-sufficiency may be accomplished for any activity.

In order to sub classify urban units according to their degree of self-sufficiency regarding the example of services contained in facilities, the following sub-classifications are proposed: 1a) Totally Non Self-Sufficient Municipality (TNSSM): the municipality may completely lack one or more basic/universal services, which are education, health, and social services. A minimal sports facility must also exist, either standing alone or as part of education or health services. 1b) Partially Non-Self Sufficient Municipality (PNSSM): one or more basic services may be below the average provided by the self-sufficient municipalities. 2a) Partially Self-Sufficient Municipality (PSSM): one or more complimentary services may not be covered. Complimentary services may include administration, safety and civil protection, culture, transport, and religion. 2b) Totally Self-Sufficient Municipality (TSSM): complimentary services may be equal to or above the averages established for self-sufficient municipalities, also known as “complete municipalities”. To further classify municipalities according to the described sub-classifications, qualitative and quantitative data may be needed on facilities for each of the compared municipalities. In that respect, data sets from governmental planning offices may be used.

In the proposed urban planning method, ICT technologies constitute the basis for gathering and processing objective data regarding urban time use of citizens, using web-based surveys and data mining tools (such as the k-nearest -neighbour (k-nn) or decision tree learning algorithms).

For the purpose of municipal classification on self-sufficiency, a decision tree learning algorithm may provide satisfactory results, as useful automatic rules for classifying municipalities beyond sufficiency values may be obtained. Therefore, a municipality may be easily classified without knowing the class (self-sufficiency). Typical urban databases containing only basic information such as municipal population or quantities of a specific land use may be enough to classify the municipality for that land use. Subsequent classification on self-sufficiency for a specific land use may be possible with larger land use data bases detailing land use characteristics.

However, urban data bases can have a number of unknown values, and this may be more problematic with larger datasets. In the proposed method, sub-classification may be possible by completing missing values of urban databases using the k-nn technique. With this technique it may be possible to successfully sub-classify the self-sufficiency condition on public services and facilities into four subgroups, making a distinction between self-sufficiency in basic and complimentary services. In a similar manner, self-sufficiency in any activity may be determined.

The usage of ICT technologies within the urban fabric may make our cities more efficient and may optimize the use of natural resources. This results in significant economic savings, protection of the environment, and higher living standards and quality of life. Under this perspective, the proposed method uses ICT technologies to develop more informed and objective planning, and thereby better achieve the main urban planning goal, which is to cover the needs of citizens. The proposed method may fill the gap of smart solutions in the urban planning arena. In addition to its benefits in the areas of municipal and regional planning, the proposed method may improve public participation in the urban planning approval process, by obtaining and considering the opinions of citizens before the design process begins. With the disclosed method, citizens may actively participate in the planning design, and provide their opinions concerning their covered and uncovered urban needs.

The disclosed method shall be explained below with reference to the respective figures.

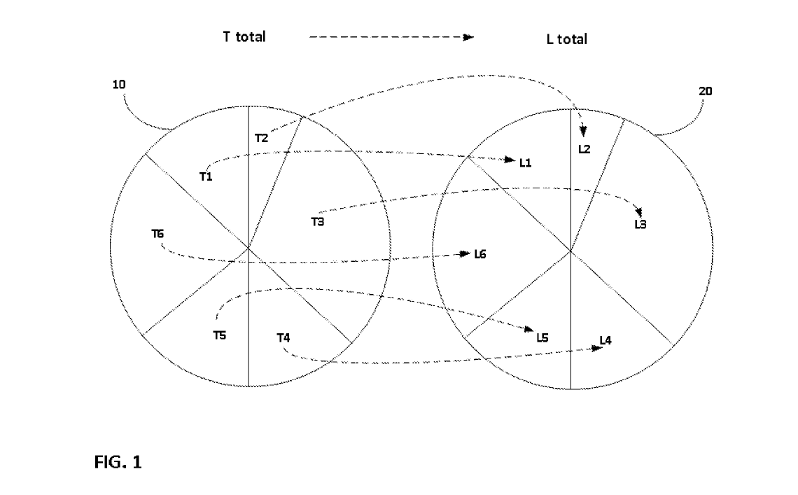

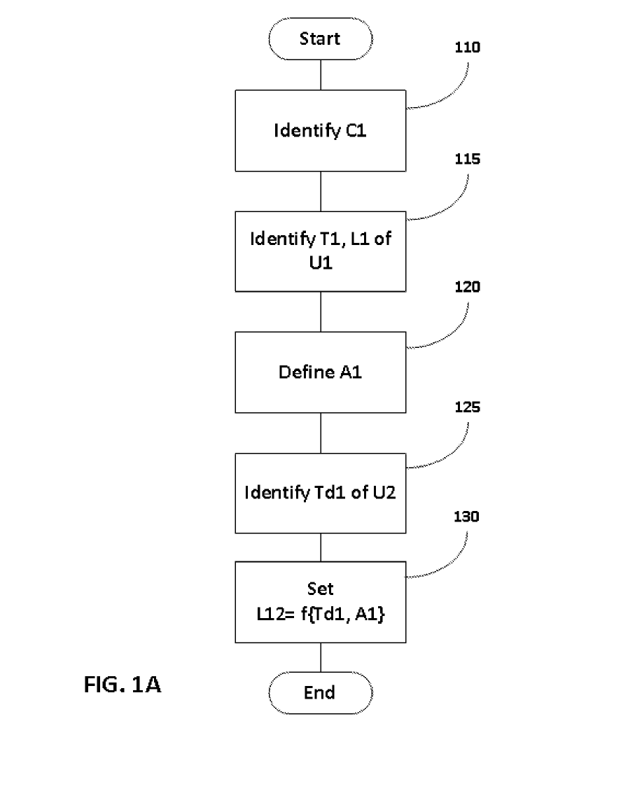

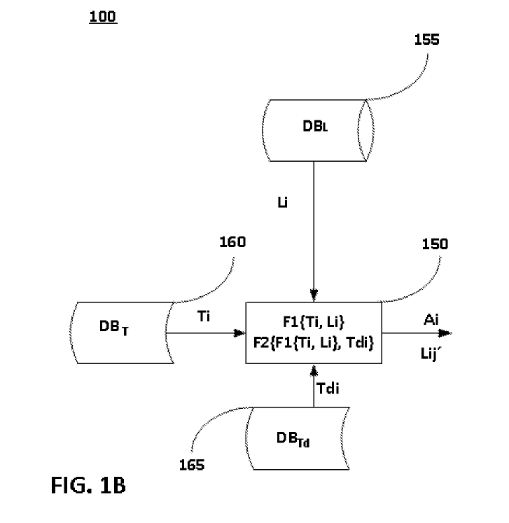

FIG. 1 shows an example of the rule of correspondence between desired time spent and land usage for a number of activities. In the drawing, the first circle 10 depicts the total time (Ttotal) during which a number of activities take place. In one example, Ttotal may be equal to 24 h. In the example of FIG. 1, six activities C1 to C6 take place during time Ttotal and each activity is desired to last T1 to T6 hours, respectively. T1 to T6 represent the total hours spent for the corresponding activities by all citizens in the urban unit U1. The second circle 20 depicts the total land area size (Ltotal) of the urban unit U1 where the six activities shall take place. The two circles are depicted of equal size to demonstrate the proportionality of the rule of correspondence of the disclosed invention. In the example of FIG. 1, T1 /Ttotal is equal to L1/Ltotal and so on. Therefore, the allocation of land in U1 for each activity C1 to C6 corresponds to the desired time T1 to T6 to be spent for each activity. Therefore the urban unit U1 may be considered designed according to the desired usage of the perceived citizens.

FIG. 1 A is a flow diagram of a method of quantitatively allocating land uses according to an embodiment. In a first step 110, an activity C1 is identified in an urban unit U1. In a next step 115, an associated time period equal to T1 is identified which corresponds to the time that the citizens of the urban unit intend to spend for the activity C1 in a land area of the urban unit having a size equal to L1. T1 is an extrapolation of the total time spent by all citizens of the urban unit doing activity C1 in a time period Ttotal that may be a complete working day (24 h) or a plurality of 24 h periods to account for activities during weekends and holidays. In a third step 120, an activity allocation parameter A1 is defined as the proportion of time T1 in the land area L1. Then, in step 125, a desired time Td1 may be identified, corresponding to the amount of desired time to be spent for activity C1 in a second urban unit U2. Finally, in a last step 130, a land area size L12 of U2 is set as a function of Td1 and A1. L12 may then be considered the sufficient land area size of the urban unit U2 for carrying out activity C1.

The process of the method may be repeated for all identified desired activities C1 to Cn during the time Ttotal. Accordingly, all land area sizes L12 . . . Ln2 may then be defined so that the total sufficient area size of urban unit U2 is defined.

FIG. 1B is a block diagram of a device for quantitatively allocating land uses according to another embodiment. Device 100 may comprise a logic module 150 and a plurality of data sources 155, 160, and 165. The logic module may receive as input a land area size Li from a first memory or database (DB_{L}) 155, from a second memory or database (DB_{T}) 160 an associated time Ti spent in an activity Ci in an urban unit Uj and from a third memory or database (DB_{Td}) a desired time Tdi to be spent in activity Ci in an urban unit Uj′. The device 100 then may be arranged to generate a activity allocation parameter Ai as a function of Ti and Li and a land area size Lij′ as a function of Ti, Li and Tdi.

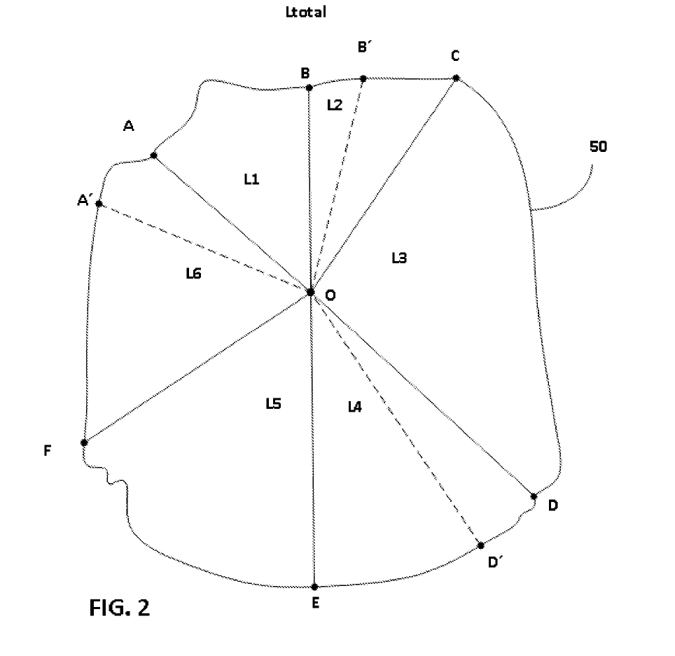

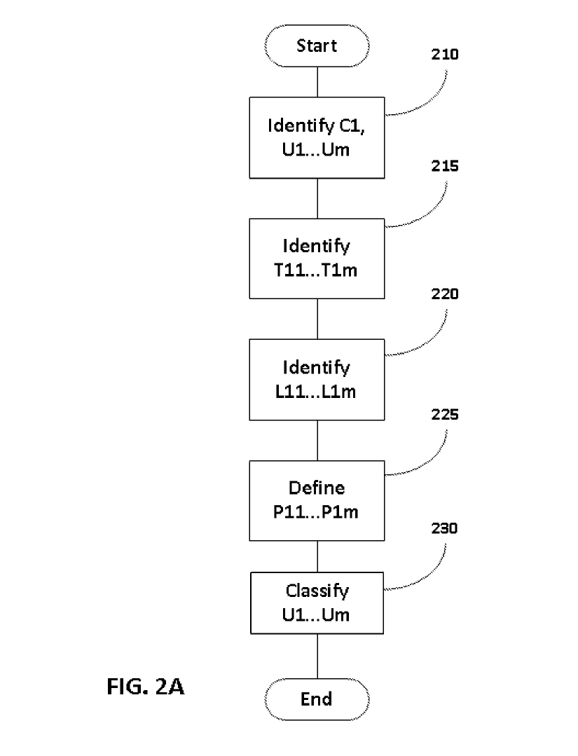

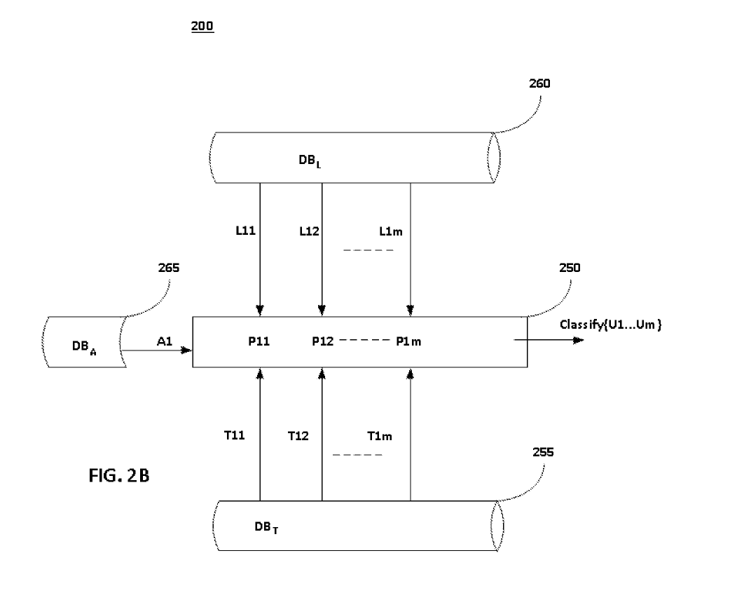

FIG. 2 shows an example redistribution of land areas in an urban unit as a result of the application of embodiments of the invention. For simplicity, a theoretical urban unit U1 as defined by limits A-B-C-D-E-F-A is shown. An ideally self-sufficient urban unit would have L1 defined by points A, O and B. Accordingly, L2 would be defined by B, O, C; L3 by C, O, D; L4 by D, O, E; L5 by E, O, F and finally L6 by F, O, A. Therefore an actual urban unit with the same population having such a distribution of land areas would fulfil the self-sufficiency criterion for all activities. Now, let's assume an actual distribution of land areas for an existing urban unit U1′. For simplicity, we assume U1 to be of equal total size to U1′ and of equal population. However, one skilled in the art my appreciate that the proposed method may compare any two urban units as the defining measure, assuming comparable populations, is the proportion of a land area devoted for a certain activity in the total land area and not the absolute size of any land area. In a realistic scenario, L1′ may be defined by A′, O, B′; L2′ may be defined by B′, O, C; L3′ may be defined by C, O, D′; L4′ may be defined by D′, O, E; L5′ may be defined by E, O, F, and finally L6′ may be defined by F, O, A′. In the example of FIG. 2, U1′ is demonstrated self-sufficient for activities C1, C3 and C5 and not self-sufficient for the activities C2, C4, C6. The reason is that the areas L1′, L3′ and L5′ of U1′ are depicted greater or equal in size to the corresponding areas L1, L3, L5 of the ideal urban unit U1. Accordingly, the areas L2′, L4′ and L6′ are depicted smaller in size than the corresponding areas L2, L4 and L6 of the ideal area U1. As a consequence, a possible redistribution of land so that the sizes of the land areas of U1′ coincide with the sizes of the land areas of U1 would have the effect that U1′ would become totally self-sufficient.

FIG. 2A is a flow diagram of a method of classifying self-sufficiency in land uses of a plurality of urban units U1 to Um according to an embodiment. In a first step 210 an activity C1 common to a plurality of urban units U1 to Um may be identified.

Then, in step 215, a plurality of associated times T11 to T1m may be identified corresponding to actual time spent in each of the urban units U1 to Um for the activity C1. Then, in step 220 a plurality of land area sizes L11 to L1m may be identified as the actual land area sizes used for the activity C1 in the urban units U1 to Um. In step 225, a plurality of performance indicators P11 to P1m may be defined. Each performance indicator may be defined as a proportion of the respective associated time to the respective land area size. In one example, P11 may be equal to T11/L11, P12 may be equal to T12/L12 and so on. Then, in step 230, the urban units U1 to Um may be classified according to their P indicators.

An example classification would be to compare the respective P indicators with an activity allocation parameter A of the respective activity. For example, all urban units having a P indicator that matches or exceeds the respective activity allocation parameter A, may be considered self-sufficient whereas otherwise the urban units may be considered not self-sufficient.

The process of the method may be repeated for all identified desired activities C1 to Cn during a time Ttotal. A plurality of associated time sets {T11 . . . T1m} . . . {Tn1 . . . Tnm} and a plurality of land area size sets {L11 . . . L1m} . . . {Ln1 . . . Lnm} may then be identified. Accordingly, a plurality of performance indicator sets {11 . . . P1m} . . . {Pn1 . . . Pnm} may then be defined to generate a comparison matrix of performance indicators. Then the matrix may be used to classify the urban units in different ways.

FIG. 2B is a block diagram of a device for classifying urban units, according to an embodiment. Device 200 may comprise a logic module 250 and a plurality of data sources DB_{T} 255, DB_{L} 260, DB_{A} 265 coupled to the logic module 250. In the example of FIG. 2B, logic module 250 may receive as input from data source 255 a plurality of associated times T11 to T1m corresponding to actual time spent for activity C1 in a total time period Ttotal in each of the urban units U1 . . . Um. Logic module 250 may receive from data source 260 a plurality of land area size values L11 to L1m corresponding to the land area used in each of the urban units U1 to Um for activity C1. Optionally, the logical unit may also receive an activity performance indicator A1 for activity C1 from data source 265. The logic module may then calculate a plurality of performance indicators P11 to P1m each indicator corresponding to the proportion the respective associated time to the land area used in an urban unit. The device may then classify the urban units based on their performance indicators. Furthermore, with the use of the performance indicators the urban units may be classified as self-sufficient or non-self-sufficient when their performance indicators are compared to the activity allocation parameters of said activity.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Reference signs related to drawings and placed in parentheses in a claim, are solely for attempting to increase the intelligibility of the claim, and shall not be construed as limiting the scope of the claim. Thus, the scope of the present invention should not be limited by particular embodiments, but should be determined only by a fair reading of the claims that follow.

1. A method of quantitatively mapping urban time use to land use, comprising:
identifying at least a first activity C1 to be carried out within a first urban unit U1;
identifying a first associated time T1 to be spent for the first activity C1;
identifying a first land area size L1 where activity C1 takes place;
defining an activity allocation parameter A1 as a proportion of T1 and L1;
identifying a first desired time Td1 as the amount of desired time to be spent for activity C1 in a second urban unit U2; and
setting a second land area size L12 of the second urban unit U2, as a function of Td1 and A1.

2. The method according to claim 1, further comprising:
identifying a plurality of activities C1 to Cn to be carried out within a plurality of urban units;
identifying a plurality of associated times T1 to Tn to be spent for the activities C1 to Cn, respectively;
identifying a plurality of land area sizes L1 to Ln where activities C1 to Cn take place, respectively;
defining a plurality of activity allocation parameters A1 to An each as a proportion of Ti and Li, respectively, i belonging to [1, . . . , n];
identifying a plurality of desired times Td1 to Tdn as the amount of desired time to be spent for activities C1 to Cn in the second urban unit U2; and
setting a plurality of land area sizes L12 to Ln2 of the second urban unit U2, each as a function of Tdi and Ai, respectively, i belonging to [1, . . . , n].

3. The method according to claim 2 wherein each of the activity allocation parameters A1 to An is based on a proportion of Ti and Li of an urban unit belonging to the plurality of urban units.

4. A method of classifying a plurality of urban units U1 to Um, comprising:
quantitatively mapping urban time use to land use according to claim 2 for the activity C1;
defining a plurality of performance indicators P11 to P1m, each corresponding to a proportion between an associated time T1j, corresponding to the time spent in urban unit Uj for activity C1, and L1j, corresponding to the land area size used for said activity C1 in urban unit Uj, j belonging to [1, . . . ,m], respectively; and
classifying the urban units U1 to Um, based on P11 to P1m.

5. The method according to claim 4, wherein when P1j≧A1 the corresponding urban unit is considered self-sufficient.

6. A method according to claim 4, further comprising:
quantitatively mapping urban time use to land use for a plurality of activities C1 to Cn;
identifying a plurality of performance indicators P11 to Pnm for the plurality of activities C1 to Cn;
classifying the urban units U1 to Um, based on P11 to Pnm.

7. The method according to claim 6, wherein when Pij≧Ai the corresponding urban unit is considered self-sufficient with respect to the activity Ci.

8. A device for quantitatively mapping urban time use to land use comprising:
a memory and a processor, embodying instructions stored in the memory and executable by the processor, the instructions comprising functionality to:
receive at least a first identifier corresponding to an activity C1 to be carried out within a first urban unit U1;
receive a first associated time value T1 corresponding to the time spent for the first activity C1;
receive a first value L1 corresponding to the land area size where activity C1 takes place;
calculate an activity allocation parameter A1 as a proportion of T1 and L1;
receive a first desired time value Td1 corresponding to the amount of desired time to be spent for activity C1 in a second urban unit U2;
calculate a second value L12 as a function of Td1 and A1, wherein L12 corresponds to the sufficient land area size of the second urban unit U2 for activity C1.

9. The device according to claim 8, further comprising instructions comprising functionality to:
receive a plurality of identifiers corresponding to activities C1 to Cn to be carried out within a plurality of urban units;
receive a plurality of associated time values T1 to Tn corresponding to the times to be spent for the activities C1 to Cn, respectively;
receive a plurality of values L1 to Ln corresponding to the land area sizes where activities C1 to Cn take place, respectively;
calculate a plurality of activity allocation parameters A1 to An each as a proportion of Ti and Li, respectively, i belonging to [1, . . . , n];
receive a plurality of desired time values Td1 to Tdn corresponding to the amounts of desired time to be spent for activities C1 to Cn in the second urban unit U2; and
calculate a plurality of values L12 to Ln2 , each as a function of Tdi and Ai, respectively, i belonging to [1, . . . , n], wherein L12 to Ln2 correspond to the sufficient land area sizes of the second urban unit U2 for the activities C1 to Cn, respectively.

10. The device according to claim 9, further comprising instructions comprising functionality to:
calculate a plurality of performance indicators P11 to P1m, each corresponding to a proportion between an associated time T1j,
wherein T1j corresponds to the time spent in urban unit Uj for activity C1, and L1j corresponds to the land area size used for said activity C1 in urban unit Uj, j belonging to [1, . . . , m], respectively; and
classify the urban units U1 to Um, based on P11 to P1m.

11. The device according to claim 10, further comprising instructions comprising functionality to:
calculate a plurality of performance indicators P11 to Pnm for the plurality of activities C1 to Cn; and
classify the urban units U1 to Um, based on P11 to Pnm.

12. A computer implemented method of quantitatively mapping urban time use to land use, comprising:
providing a computer executable logic module, said logic module:
receiving at least a first identifier corresponding to an activity C1 to be carried out within a first urban unit U1;
receiving a first associated time value T1, corresponding to the time spent for the first activity C1 in urban unit U1;
identifying a first value L1 corresponding to the size of the land area where activity C1 takes place;
calculating an activity allocation parameter A1 as a proportion of T1 and L1;
identifying a first desired time value Td1 corresponding to the amount of desired time to be spent for activity C1 in a second urban unit U2; and
calculating a second value L12 corresponding to the sufficient size of the land area of the second urban unit U2, as a function of Td1 and A1.

13. The computer implemented method according to claim 12, said logic module further:
receiving a plurality of identifiers corresponding to activities C1 to Cn to be carried out within a plurality of urban units;
receiving a plurality of associated time values T1 to Tn corresponding to the times spent for the activities C1 to Cn, respectively;
receiving a plurality of values L1 to Ln corresponding to the sizes of the land areas where activities C1 to Cn take place, respectively;
calculating a plurality of activity allocation parameters A1 to An each as a proportion of Ti and Li, respectively, i belonging to [1, . . . , n];
receiving a plurality of desired time values Td1 to Tdn corresponding to the amounts of desired time spent for activities C1 to Cn in the second urban unit U2; and
calculating a plurality of land area sizes L12 to Ln2 of the second urban unit U2, each as a function of Tdi and Ai, respectively, i belonging to [1, . . . , n].

14. The computer implemented method according to claim 13, said logic module further:
calculating a plurality of performance indicators P11 to P1m, each corresponding to a proportion between an associated time T1j,
wherein T1j corresponds to the time spent in urban unit Uj for activity C1, and L1j corresponds to the land area size used for said activity C1 in urban unit Uj, j belonging to [1, . . . , m], respectively; and
classifying the urban units U1 to Um, based on P11 to P1m.

15. The computer implemented method according to claim 14, said logic module further:
calculating a plurality of performance indicators P11 to Pnm for the plurality of activities C1 to Cn; and
classifying the urban units U1 to Um, based on P11 to Pnm.
